(19) United States
(12) Patent Application Publication
(10) Pub. No.: US 2005/0262635 A1
(43) Pub. Date: Dec. 1, 2005

(54) Tilt bed

(76) Inventor: Thomas W. Wing, Claremont, CA (US)

Correspondence Address: Kit M. Stetina, Esq.;STETINA BRUNDA GARRED & BRUCKER, 75 Enterprise, Suite 250, Aliso Viejo, CA, 92656, US

(21) Appl. No.: 10/856,614

(22) Filed: May 28, 2004

(51) Int. Cl. A61G 7/008

(52) U.S. Cl. 5/607; 5/617

(57) ABSTRACT

A tilt bed assembly, having a bed frame, a tilt bed installed in the bed frame, and at least a first linear motor for tilting the tilt bed along a desired direction with a desired degree. The bed frame has a horizontal base panel, a first vertical panel and a second vertical panel. The first and second vertical panels support the base panel and each of the first and second vertical boards is perforated with a hole. The tilt bed has a first vertical board, a second vertical board and a base board connecting to lower edges of the first and second vertical boards. The first vertical board has a first axle member extending from an exterior surface thereof. The first axle member extends through the hole of the first vertical panels. The second vertical board includes a second axle member extending from an exterior surface thereof. The second axle member is aligned with the first axle member, and the second axle member extends through the hole of the second vertical panels. The base extends horizontally over the base panel of the bed frame and between the first vertical board and the vertical second board. The tilt bed assembly further has a first linear motor mounted to an exterior surface of the first vertical panel of the bed frame, and a rotation arm having a first end in mechanical communication with the linear motor and a second end in mechanical communication with the axle member.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates in general to a tilt bed, and more particular, to a tilt bed operative to adjust positions of a patient lying thereon.

Millions of persons are forced in beds temporarily or permanently. Persons who are confined in beds for extended periods of time are at risk of developing problems such decubitus ulcers, that is, pressure sores or bed sores as they are more commonly known. The ulcers are often seen to develop within soft tissue that is compressed between a bed surface and a patient's weight-bearing bony prominences. The soft tissue being compressed by the patient's weight is at least partially deprived of oxygenated blood flow. Continuously lack of oxygenated blood blow may result in cell death which is frequently evidenced in the form of pressure sours.

To avoid the development of decubitus ulcer in bedfast patients, the positions of the patients are normally adjusted every two hour intervals. For example, a patient in a back rest position is periodically rolled to one side or the other every two hours. The usual procedure is to drag the patient by tugging on bed sheet every to hours to a new position. Obviously, such adjustment strategy of the patient is very laborious for the caregivers, particularly for the sole caregiver. More importantly, it is very easy for the busy caregivers to skip or forget performing position adjustment for the patient in the press of other daily business. Further, as the patient will be easily awakened by the service manually performed every two hours, it is also disruptive to the patient who is soundly sleeping.

There is thus a substantially need to provide a tilt bed operative to adjust the position of a patient lying thereon to a desired position without awakening the soundly sleeping patients. Preferably, the intervals for such adjustment can be programmed according to specific need of the patient, and the position adjustment can be performed automatically.

### BRIEF SUMMARY OF THE INVENTION

The present invention provides a tilt bed assembly which comprises a bed frame, a tilt bed installed in the bed frame, and at least a first linear motor for tilting the tilt bed along a desired direction with a desired degree. The bed frame comprises a horizontal base panel, a first vertical panel and a second vertical panel. The first and second vertical panels support the base panel and each of the first and second vertical boards is perforated with a hole. The tilt bed comprises a first vertical board, a second vertical board and a base connected to lower edges of the first and second vertical boards. The first vertical board includes a first axle member extending from an exterior surface thereof. The first axle member extends through the hole of the first vertical panels. The second vertical board includes a second axle member extending from an exterior surface thereof. The second axle member is aligned with the first axle member, and the second axle member extends through the hole of the second vertical panels. The base extends horizontally over the base panel of the bed frame and between the first vertical board and the vertical second board. The tilt bed assembly further comprises a first linear motor mounted to an exterior surface of the first vertical panel of the bed frame, and a rotation arm having a first end in mechanical communication with the linear motor and a second end in mechanical communication with the first axle member.

The first linear motor is operative to actuate the rotation arm rotating about a longitudinal axis of the first axle member, and the rotation arm is operative to rotate the first axle member about the longitudinal axis thereof while being actuated by the first linear motor. The second axle member is rotating about its longitudinal axis as a consequence of the rotation of the first axle member. The first linear motor may be controlled by a control system for automatically actuating the rotation arm and rotate the first axle member. The control system comprises an input device for inputting parameters of the first linear motor and a processor in electric communication with the input device and a power supply of the first linear motor. The processor is operative to control the output of the first linear motor according to the parameters input by the input device. The parameters include the angle, duration, and interval for tilting the tilt bed. In one embodiment, the control system further comprises a display for displaying or monitoring the parameters of the first linear motor. The control system may also comprise a memory for storing the parameters input from the input device.

To elevate either head portion or foot portion of a patient lying on the tilt bed, the tilt bed assembly further comprises a second linear motor mounted to a lower surface of the base of the tilt bed and a lift arm in communication with the second linear motor. The second linear motor lift is operative to actuate the lift arm lifting upwards towards a first portion of the base of the tilt bed. In one embodiment, the first portion includes a door hinged with a second portion of the base. Therefore, by applying a force against the first portion, the first portion is operative to rotate about the hinge. The control system for controlling the first linear motor is also operative to control the second linear motor and the lift arm. Similarly, the user may input parameters of the second linear motor via the input device, and the parameters may be monitored and displayed by a display. The input device and the display may be integrated into a single user interface. The processor is electrically connected to the input device and a power supply of the second linear motor. Therefore, the processor is operative to control the output of the linear motor according to the parameters. The parameters can be stored in a memory. Alternatively, the first linear motor and the second linear motor may be controlled by individual control systems.

The present invention further provides a tilt bed which can be installed in a regular hospital bed or sick bed. The tilt bed includes two vertical end boards, an elongate horizontal board having a pair of opposing ends adjacent to lower edges of the end boards and a pair of opposing sides between the opposing ends, and a pair of aligned axle members extending perpendicular from the respective end boards. One of the axle members is in mechanical communication with one of the axle members, such that the rotation arm is operative to tilt one side of the horizontal board higher than the other side thereof by rotating the one axle member about an elongate axis thereof.

Although the tilt bed can be tilted manually to a desired angle or height, preferably, a motor operative to actuate rotation of the rotation arm and one of the axle members is incorporated. The elongate horizontal board may further comprise a first portion hinged with a second portion thereof. To raise the body portion of the patient on the first portion of the tilt bed, a lift arm is installed under the first portion. The lift arm can be raised or lifted towards the first portion of the tilt bed. When the lift arm reaches the first portion, the continuous lifting or raising movement of the lift arm elevates the first portion above the remaining portion of the tilt bed. Similar to the rotation arm, although the lift arm can be operated manually, it is preferably that the lift arm is in electrical communication with a motor. The motor is operative to output a force or a torque to actuate the lifting movement of the lift arm.

### BRIEF DESCRIPTION OF THE DRAWINGS

These as well as other features of the present invention will become more apparent upon reference to the drawings therein:

FIG. 1 illustrates a perspective view of a tilt bed installed in a general hospital bed;

FIG. 2 illustrates a side view of the tilt bed installed in the general hospital bed as shown in FIG. 1;

FIG. 3 illustrates a block diagram of a control system for controlling the movement of the tilt bed as shown in FIGS. 1 and 2; and

FIG. 4 illustrates a block diagram of another embodiment of the automatic control system.

### DETAILED DESCRIPTION OF THE INVENTION

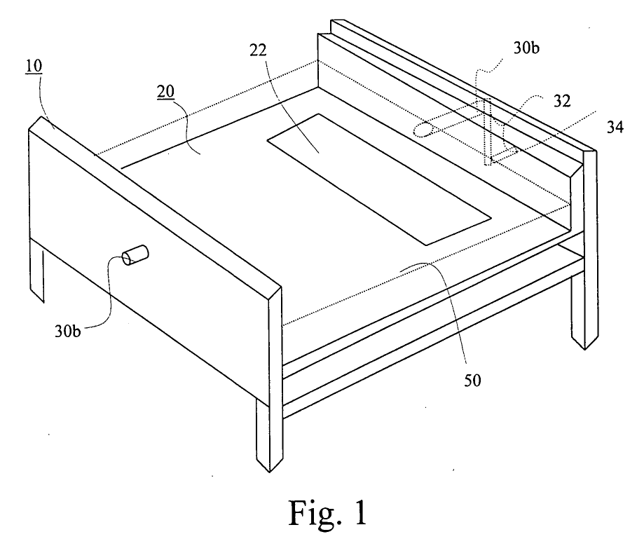

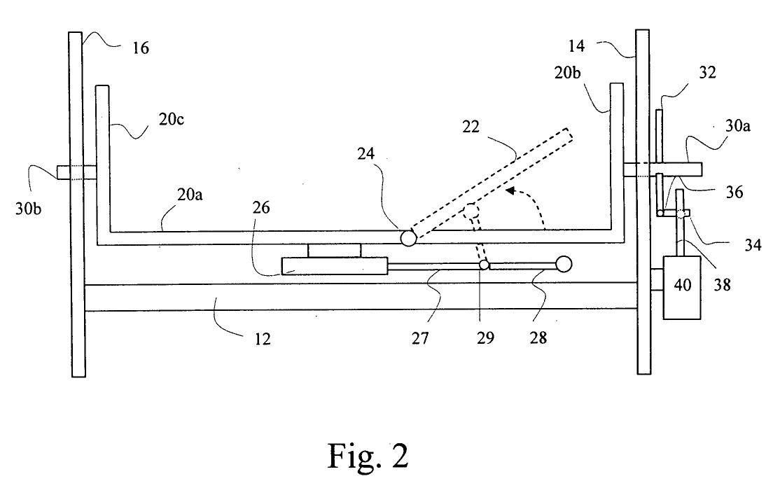

Referring now to the drawings wherein the showings are for purpose of illustrating preferred embodiments of the present invention only, and not for purposes of limiting the same. FIG. 1 illustrates a perspective view of a tilt bed 20 installed in a bed frame 10 such as a general hospital bed, and FIG. 2 shows a side view of the tilt bed 20 and the bed frame 10. As shown in FIG. 2, the bed frame 10 includes a base panel 12 supported by a head panel 14 and a foot panel 16. Each of the head panel 14 and the foot panel 16 is perforated with a through hole. The tilt bed 20 includes an elongate platform 20a, and a head board 20b and a foot board 20c extending upwardly from two opposing ends of the platform 20a. To install the tilt bed 20 in the bed frame 10, the head board 20b and the foot board 20c include a pair of axle members 30a and 30b projecting perpendicularly from exterior surfaces thereof to extend through the holes formed in the head panel 14 and the foot panel 16, respectively. To allow maneuver of the tilt bed 20 over the base panel 12 of the bed frame 10, as shown in FIG. 2, the platform 20a of the tilt bed 20 is placed over the base panel 12 of the bed frame 10 with a predetermined gap. The gap is sufficiently large to allow installation of a linear motor 26 underneath the platform 20a, and also provides enough space for the tilt bed 10 to tilt about the axles 30a and 30b with a predetermined angle. In another aspect, the base panel 12 also prevents the tilt bed 20 from overly tilting or rotating to a height or degree from which the patient lying thereon will fall.

As shown in FIG. 2, the tilting mechanism of the tilt bed 20 includes a linear motor 40, a torque tube 38, a horizontal arm 34 and a rotation arm 32. The linear motor 40 is operative to generate a force actuating swinging motion of the torque tube 38. The torque tube 38 is operative to swing left or right along a vertical plane in response to the force generated by the linear motor 40. The swinging direction of the torque tube 38 determines the tilting direction of the tilt bed 20 and the patient lying thereon. The torque tube 38 is in mechanical communication with the horizontal arm 34 such that when the torque tube 38 is actuated to swing, the torque generated by the torque tube 38 drives the horizontal arm 34 to displace. The horizontal arm 34 is linked with the bottom end 36 of the rotation arm 32, and the top end of the rotation arm 32 extends transversely through the axle member 30b. Thereby, the displacement of the horizontal arm 34 drives the rotation arm 32 to rotate about the bottom end 36, and the rotation of the rotation arm 32 drives the axle member 30b to rotate about an elongate axis thereof. As the axle 30b rotates, the tilt bed 10 is tilted with an angle determined by the rotation angle of the rotation arm 32, which further depends on the displacement of the horizontal arm 34 and the force generated by the linear motor 40. Therefore, to tilt the tilt bed 20 towards a desired direction with a specific angle, one can simply controls the magnitude and direction of the force output from the linear motor 40.

FIG. 2 further illustrates the elevating mechanism of the platform 20a of the tilt bed 10. As shown, the head portion 22 of the platform 20a is in a form of a door hinged with the lower portion of the platform 20a at a hinge portion 24. A linear motor 26 is attached to the bottom surface of the platform 20a over the base panel 12 of the bed frame 10. The linear motor 26 includes a torque tube 27 and a lift arm 28 pivotally connected to the torque tube 27. The linear motor 26 is operative to generate a torque supplied to the torque tube 27, and the torque tube 27 is operative to drive the lift arm 28 rotating about the pivot 29. When the lift arm 28 rotates to a position indicated by the dash line 29a, the head portion 22 is lifted by the lift arm 28 to an elevated position illustrated by the dash line 22. Similar to the tilting action as mentioned above, the head portion 22 can be lifted to a desired height by controlling the torque output from the linear motor 26.

In one embodiment, the platform 20a of the tilt bed 20 may include an exterior case in which tubes for storing circulating liquid are embedded. The circulating liquid does not only provide heating and/or cooling functions to the patient lying on the tilt bed 20, but also serves as a vibrator to stimulate various areas of the patient body. Alternatively, the platform 20a may serve as a supporting unit for carrying a mattress 50 thereon. The mattress 50 may then includes embedded tubes for storing circulating liquid or other cooling and/or heating elements.

As mentioned above, the bed frame 10 includes a typical hospital bed or a hospital type home patient bed which includes a head raising mechanism and a foot raising mechanism. The head raising mechanism is typically mounted to the head board, that is, the head panel 14, as shown in FIGS. 1 and 2. In this invention, the head raising mechanism is converted into the tilting mechanism, while the foot raising mechanism typically mounted underneath the base panel 12 is now converted into the head raising mechanism mounted between the base panel 12 of the bed frame 10 and the tilt bed 20. Therefore, the tilt bed assembly as shown in FIGS. 1 and 2 can be easily manufactured and applied to typical hospital or home patient beds.

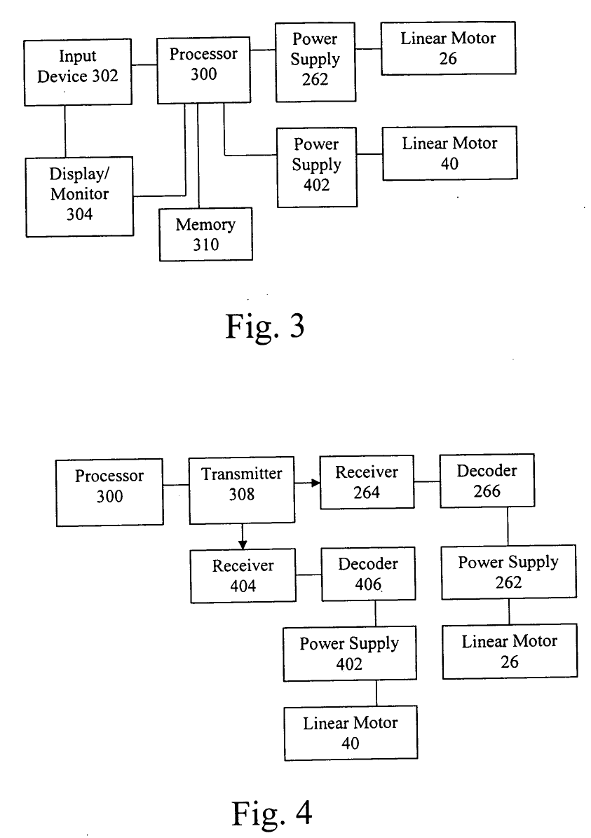

The structure as disclosed above employs linear motors 26 and 40 to actuate elevation of a portion of a bed and tilting movement of the bed from one side to the other, respectively. Although the linear motors 26 and 40 can be activated manually, it is preferable that an automatic control system is incorporated to automatically activate the linear motors 26 and 40. Thereby, the position adjustment of the patient is prevented from being skipped or forgot by the caregivers. FIG. 3 shows a block diagram of a device for controlling the linear motors 26 and 40 to automatically and routinely adjust position of the patient. As shown, the linear motors 26 and 40 are in electric communication with the power supplies 262 and 402, respectively. The power supplies 262 and 402 can be integrated into a single power supply including multiple individual output terminals. The power supplies 262 and 402 are operative to provide power to the linear motors 26 and 40, respectively, such that the linear motors 26 and 40 can be activated to generate force for driving the elevating mechanism and the tilting mechanism as shown in FIG. 2. The power supplies 262 and 402 are in electrical communication with a processor 300, such that the output of the power supplies 262 and 402 can be controlled by the processor 300. The device further comprises a user interface allowing the user, particularly the caregiver, to input parameters, including the intervals for performing the position adjustment, the required position of the patient and the required movement such as elevating the upper body of the patient or tilting one side of the patient. The user interface may includes an input device 302 such as a keyboard or a mouse and a display or a monitor 304 which allows the user to monitor the input parameters and/or current position of the patient and the data input by the user. Alternatively, the input device 302 and the display 304 may be integrated as a touch screen which provides both the input function of the input device 302 and the display function of the display 304 within the same structure. In this embodiment, the processor 300 includes the central processing unit of a computer in various forms. For example, the computer may be a desktop computer, a laptop computer, a workstation, a personal data assistant. Alternatively, each of the linear motors 26 and 40 may includes a built-in processor 300, a built-in user interface. Therefore, the user can input parameters into the respective motors 26 and 40 to automatically perform the required movement of the tilt bed 20 and position adjustments of the patient.

FIG. 4 shows another embodiment of the automatic control system of the linear motors 26 and 40. As shown, a computer 306 comprises a transmitter 308 is provided. The computer 306 allows the caregiver to input the data to perform required position adjustment of the patient. When the data are input in the computer 306, the computer 306 transmits signals via a built-in transmitter 308. The linear motors 26 and 40 include receivers 264 and 404 operative to receive the signals transmitted by the transmitter 308, respectively. The linear motors 26 and 40 further comprise decoders 266 and 406 for decoding the signals received by the receivers 264 and 404 into formats readable to the power supplies 262 and 402 of the linear motors 26 and 40. Thereby, the linear motors 26 and 40 generate force with required magnitude and direction to elevate and tilt the tilt bed 20 to a desired position. It will be appreciated that the power supplies 262 and 402 and the decoders 264 and 404 may be built-in devices of the linear motors 26 and 40. In addition, the transmitter 308 and the receivers 264 and 404 may be operative to transmit and receive wireless signals such as radio frequency signals and infrared signals. In the embodiments as shown in FIGS. 3 and 4, the control device may further comprises a memory 310 in electrical communication with the processor 300, such that the data input by the user can be stored.

This disclosure provides exemplary embodiments of tilt beds. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A tilt bed assembly, comprising:
a bed frame, comprising a horizontal base panel, a first vertical panel and a second vertical panel, the first and second vertical panels supporting the base panel and each of the first and second vertical boards being perforated with a hole;
a tilt bed, comprising:
first vertical board, including a first axle member extending from an exterior surface thereof, the first axle member further extending through the hole of the first vertical panels;
a second vertical board, including a second axle member extending from an exterior surface thereof, the second axle member being aligned with the first axle member, and the second axle member further extending through the hole of the second vertical panels; and
a base, extending horizontally between lower edges of the first vertical board and the vertical second board over the base panel of the bed frame;
a first linear motor, mounted to an exterior surface of the first vertical panel of the bed frame; and
a rotation arm having a first end in mechanical communication with the linear motor and a second end in mechanical communication with the first axle member.

2. The tilt bed assembly of claim 1, wherein the first linear motor is operative to actuating the rotation arm rotating about a longitudinal axis of the first axle member, and the rotation arm is operative to rotate the first axle member about the longitudinal axis thereof while being actuated by the first linear motor.

3. The tilt bed assembly of claim 2, further comprising a control system for automatically actuate the rotation arm and rotate the first axle member, the control system comprises:
an input device for inputting parameters of the first linear motor; and
a processor in electric communication with the input device and a power supply of the first linear motor.

4. The tilt bed assembly of claim 3, wherein the processor is operative to control the output of the first linear motor according to the parameters input by the input device.

5. The tilt bed assembly of claim 3, wherein the parameters include an angle for tilting the tilt bed.

6. The tilt bed assembly of claim 3, wherein the parameters include duration for tilting the tilt bed.

7. The tilt bed assembly of claim 3, wherein the parameters include intervals for tilting the tilt bed.

8. The tilt bed assembly of claim 3, wherein the control system further comprises a display for displaying or monitoring the parameters of the first linear motor.

9. The tilt bed assembly of claim 3, wherein the control system further comprises a memory for storing the parameters input from the input device.

10. The tilt bed assembly of claim 1, further comprising a second linear motor mounted to a lower surface of the base of the tilt bed.

11. The tilt bed assembly of claim 10, further comprising a lift arm in communication with the second linear motor.

12. The tilt bed assembly of claim 11, wherein the second linear motor lift being operative to actuate the lift arm lifting upwards towards a first portion of the base of the tilt bed.

13. The tilt bed assembly of claim 12, wherein the first portion includes a door hinged with a second portion of the base.

14. The tilt bed assembly of claim 1, further comprising a control system operative to control the second linear motor and the lift arm, the control system includes:
a user interface for inputting parameters of the second linear motor; and
a processor in electric communication with the user interface and a power supply of the second linear motor.

15. The tilt bed assembly of claim 14, wherein the user interface is operative to display the parameters of the second linear motor.

16. The tilt bed assembly of claim 14, wherein the user interface includes an input device.

17. The tilt bed assembly of claim 16, wherein the user interface further comprises a display.

18. The tilt bed assembly of claim 14, wherein the control system further includes a memory for storing the parameters.

19. A tilt bed, comprising:
two vertical end boards;
an elongate horizontal board, the elongate horizontal has a pair of opposing ends adjacent to lower edges of the end boards and a pair of opposing sides between the opposing ends;
a pair of aligned axle members extending perpendicular from the respective end boards; and
a rotation arm in mechanical communication with one of the axle members, the rotation arm being operative to tilt one side of the horizontal board higher than the other side thereof by rotating the one axle member about an elongate axis thereof.

20. The tilt bed of claim 19, further comprising a motor operative to actuate rotation of the rotation arm and the one axle member.

21. The tilt bed of claim 19, wherein the elongate horizontal board comprises a first portion hinged with a second portion thereof.

22. The tilt bed of claim 21, further comprising a lift arm operative to elevate the first portion higher than the second portion.

23. The tilt bed of claim 22, further comprising a motor operative to actuate the lift arm elevating the first portion.
